(19) United States
(12) Patent Application Publication
(10) Pub. No.: US 2026/0366866 A1
(43) Pub. Date: Nov. 19, 2026

(54) PIPE ANGLE FINDING SYSTEM

(71) Applicant: Daimel J. Cala, Panama City, FL (US)

(72) Inventor: Daimel J. Cala, Panama City, FL (US)

(21) Appl. No.: 19/209,059

(22) Filed: May 15, 2025

(51) Int. Cl. G01B 11/27; F16L 1/10

(52) U.S. Cl. CPC G01B 11/27; F16L 1/10

(57) ABSTRACT

A pipe angle finding system includes an elongated pipe mount body having a top wall and a pair of side arms that extend downward to create a U-shaped channel. The U-shaped channel is sized to receive a pipe between the sidewalls. A cradle having a bottom wall and a U-shaped channel that extends upward therefrom is rotatably connected onto the top wall of the pipe mount body so as to rotate along a first axis. A laser marking device is rotatably positioned within the U-shaped channel of the cradle to rotate along a second axis. The laser marking device selectively emits a visible laser beam along the first and second axis as oriented by the cradle. Markers positioned along the pipe mount body, the cradle and laser marking device work together to provide a visual indicator of the angle at which the laser marking device is oriented.

### TECHNICAL FIELD

The present invention relates generally to the field of plumbing, and more particularly to a system for determining proper angles and aligning pipe fittings.

### BACKGROUND

The statements in this section merely provide background information related to the present disclosure and may not constitute prior art.

Most piping installations require changes of direction. When using rigid pipes such as PVC, PEX, copper or Galvanized steel pipes, for example, the change in direction is affected with elbow-type fittings that attach to lengths of straight pipe. Although any size may be custom made, the majority of conventional pipe elbows are produced in fixed angular increments such as 90, 60, 45, and 22½ degrees, for example.

When installing or replacing pipes that transition between a horizontal orientation and a vertical orientation, it can be extremely difficult for the installer to properly algin the pipes using standard fittings. Indeed, this process typically requires the installer to utilize one or more mathematical equations to determine proper vertical and horizontal angles. Once determined, they must cut the pipes and hope their calculations were correct, all without ever having any sort of visual guide. Because this skill takes many years to master, it is not uncommon for the majority of workers to fail the first time, thus causing delays in the project and an increase in material costs for the wasted pipes.

Accordingly, it would be beneficial to provide a pipe angle finding system that can be utilized to quickly and easily provide a visual guide for allowing users to align and connect rigid pipes of different orientations together so as to overcome the drawbacks noted above.

### SUMMARY OF THE INVENTION

The present invention is directed to a pipe angle finding system. One embodiment of the present invention can include an elongated pipe mount body having a top wall and a pair of side arms that extend downward to create a U-shaped channel. The U-shaped channel is sized so as to be positioned along a pipe with the pipe being located beneath or between the sidewalls.

One embodiment of the present invention can also include a cradle having a bottom wall and a U-shaped channel that extends upward therefrom. The cradle can be rotatably connected onto the top wall of the pipe mount body so as to rotate along a first axis.

In one embodiment, a laser marking device can be positioned within the U-shaped channel of the cradle. The laser marking device can emit a visible laser beam along the first axis as oriented by the cradle. In one embodiment, the laser marking device can be rotatably connected to the cradle so as to rotate along a second axis.

In one embodiment, markers along the pipe mount body, cradle and laser marking device work together to provide a visual indicator of the angle at which the laser marking device is oriented along the first and second axes.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of the pipe angle finding system, in accordance with one embodiment of the invention.

FIG. 2 is a perspective view of the pipe mount body of the pipe angle finding system, in accordance with one embodiment of the invention.

FIG. 3A is a perspective view of the cradle body of the pipe angle finding system, in accordance with one embodiment of the invention.

FIG. 3B is a perspective view of the pipe mount body and cradle body of the pipe angle finding system, in accordance with one embodiment of the invention.

FIG. 4A is a perspective view of the laser marking device of the pipe angle finding system, in accordance with one embodiment of the invention.

FIG. 4B is a perspective view of the pipe angle finding system, in accordance with one embodiment of the invention.

FIG. 5 is a perspective view of the pipe angle finding system in operation, in accordance with one embodiment of the invention.

FIG. 6 is another perspective view of the pipe angle finding system in operation, in accordance with one embodiment of the invention.

FIG. 7 is a perspective view of a completed pipe assembly demonstrating the functionality of the pipe angle finding system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors”.

Several nonlimiting examples of connectors include, but are not limited to, thread-to-connect, twist-to-connect, and push-to-connect type devices, opposing strips of hook and loop material (e.g., Velcro®), attractively oriented magnetic elements or magnetic and metallic elements, buckles, clamps, sockets, clips, carabiners, and compression fittings, for example.

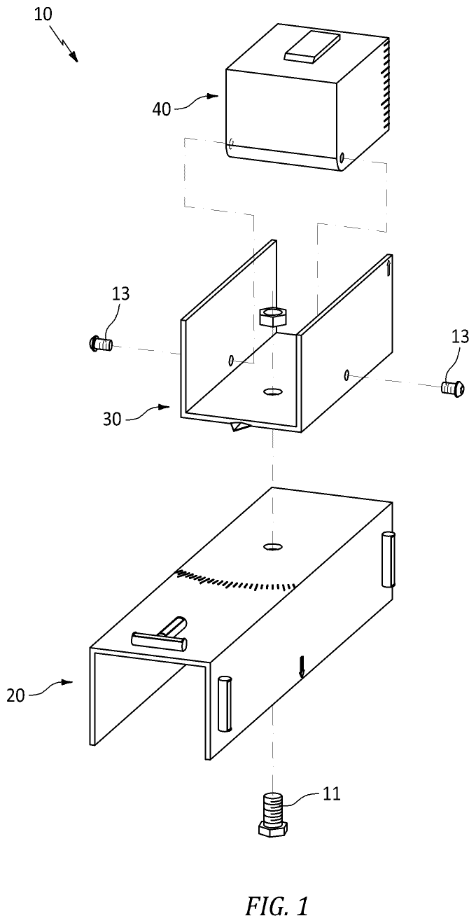

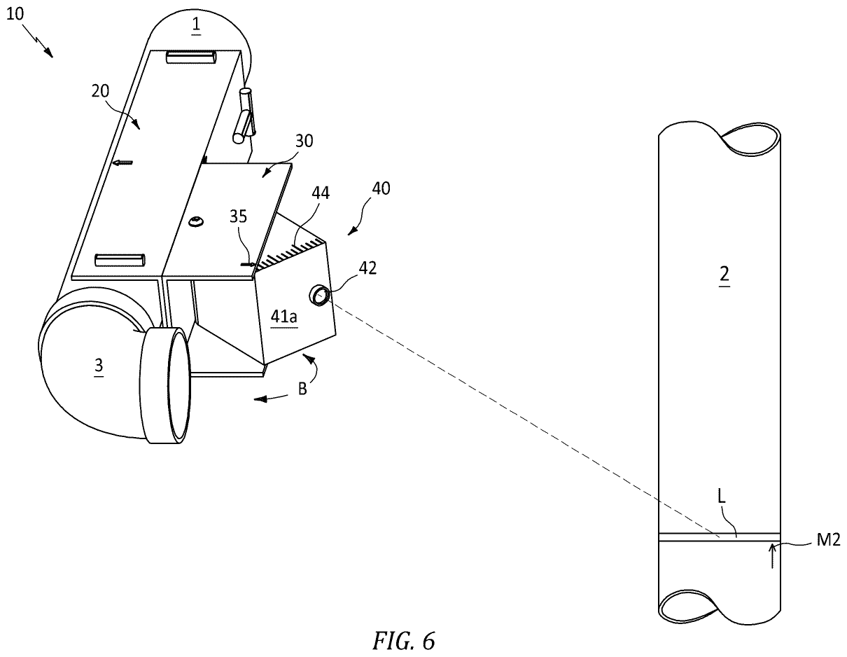

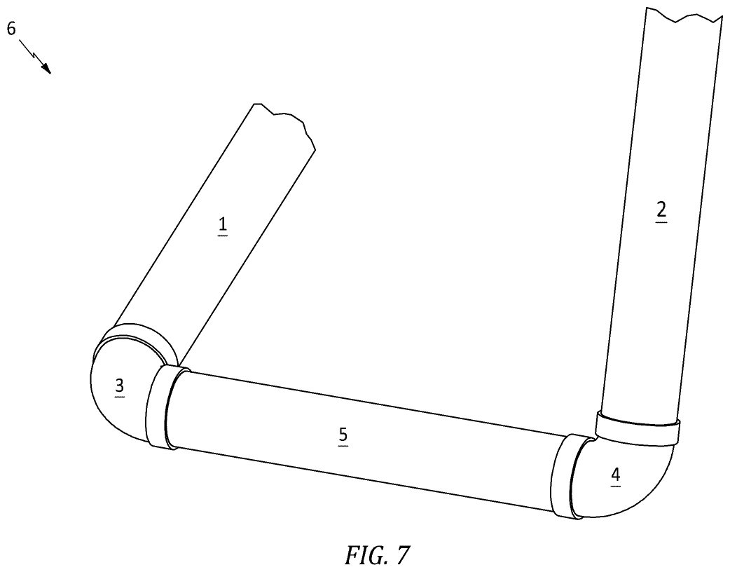

FIGS. 1-7 illustrate one embodiment of a pipe angle finding system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of the pipe angle finding system 10 that includes a pipe mount 20, and a rotating cradle 30 for housing a laser marking device 40.

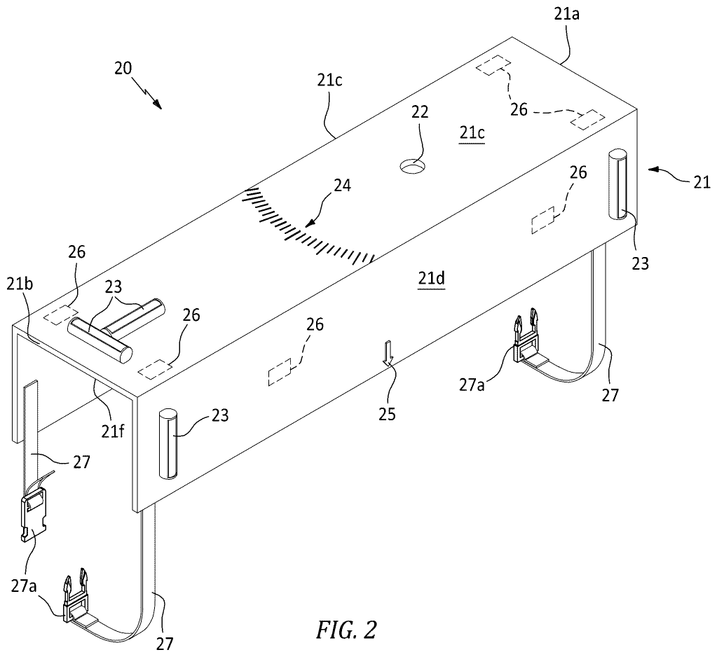

As shown at FIG. 2, the pipe mount 20 can include an elongated body 21 having a front end 21a, a back end 21b, a top wall 21c and a pair of sidewalls 21d and 21e that extend downward from the top wall to form a U-shaped channel 21f. As will be described below, the body 21 is designed to receive a pipe within or below the channel during use and can therefore be constructed to include any number of widths (e.g., distance between the sidewalls).

The body may be formed from materials that are, for example, relatively strong and stiff for their weight. Several nonlimiting examples include but are not limited to various metals or metal alloys (e.g., aluminum, steel, titanium, or alloys thereof), plastic/polymers (e.g., high-density polyethylene (HDPE), rigid polyvinyl chloride (PVC), and/or various composite materials (e.g., carbon fibers in a polymer matrix, fiberglass, etc.).

In one embodiment, a mounting hole 22 can be provided along the top wall 21c of the pipe mount. The mounting hole can function to receive a mounting bolt 11 or other such hardware for securing the cradle 30 onto the pipe mount 20 in a manner that permits the cradle to rotate relative to the pipe mount. Additionally, the pipe mount 20 can include a plurality of level indicators 23 such as the illustrated bubble levels, for example.

In one embodiment, the pipe mount 20 can include a plurality of horizontal angle indication markings 24 that are positioned along the top wall 21c. The markings can function with the below described first angle indicator 34 to provide a visual indication of the rotational angle at which the cradle/laser device are oriented relative to the pipe mount. In the preferred embodiment, the markings can include a series lines, dots and/or numbers that are arranged in a semicircular manner. The marks can be arranged to indicate any number of different relative angles such as 90, 60, 45, and 22½ degrees, for example, as these are the most commonly used type of elbow fittings. Of course, other angles and/or types of markings are also contemplated.

In one embodiment, the pipe mount can also include pipe fitting centerline markings 25 that are positioned along each of the sidewalls. As will be described below, the centerline marking provides the user with a visual representation of where the center of an elbow fitting should be positioned when using the system.

In one embodiment, the pipe mount can include one or more pipe attachment members that can removably secure the mount onto a pipe during operation of the system. For example, the mount 20 can include a plurality of magnets 26 that can be positioned anywhere along the mount body and can function to secure the mount onto a metal pipe. Additionally, the pipe mount can include one or more straps 27 that can extend downward from the sidewalls. Each of the straps can be permanently or removably connected to the mount body and can also include connectors 27a such as the illustrated buckles, for example, to permit a user to adjust the length of the strap and to securely attach the pipe mount 20 onto a pipe when using the system. Of course, other devices for securing the system onto a pipe are also contemplated.

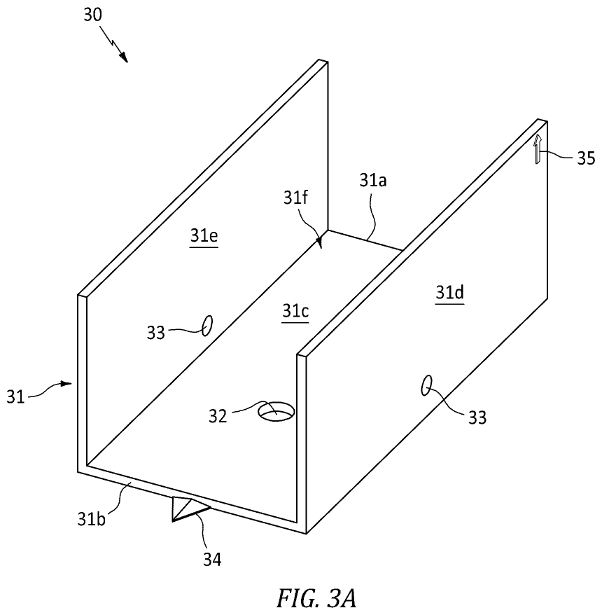

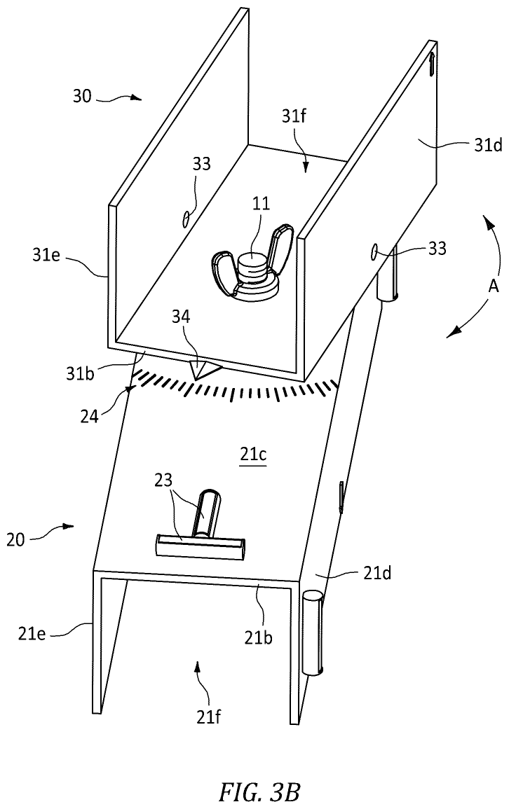

As shown at FIGS. 3A and 3B, the cradle 30 can include an elongated body 31 having a front end 31a, a back end 31b, a bottom wall 31c and a pair of sidewalls 31d and 31e that extend upward from the bottom wall to form a U-shaped channel 31f into which the below described laser marking device 40 will be positioned.

The body 31 can be formed from the same materials as the pipe mount 20, and can also include a mounting hole 32 along the bottom wall 31c. When the cradle 30 is positioned onto the pipe mount 20, mounting holes 22 and 32 can be aligned to receive the mounting bolt 11 and wing nut 12 or other such connector to secure the cradle onto the pipe mount 20 in a manner that permits the cradle to rotate in a first axis (e.g., horizontally) relative to the pipe mount as shown by arrow A.

In one embodiment, the cradle can include a pair of openings 33 along the side walls for receiving bolts 13 or other such connectors to secure the laser marking device 40 into the channel 31f. The positioning of the openings and mounting hardware are designed to allow the front of the device 40 to rotate in a second axis (e.g., vertically) relative to the cradle and pipe mount.

In one embodiment, the cradle 30 can include a first (e.g., horizontal) angle indicator 34 along the second end of the body 31. As shown, when the cradle and pipe mount are connected together, the first angle indicator 34 will be positioned adjacent to the rotational angle indication markings 24 to indicate the relative angle at which the cradle/laser device is to the pipe mount.

In one embodiment, the cradle can also include a second (e.g., vertical) angle indicator 35 along one or both of the side walls 31d and 31e at a location adjacent to the front end of the body 31. The second indicator can be positioned adjacent to the below described vertical angle indication markings 44 to indicate the relative angle at which the beam emitted by the device 40 is positioned relative to the cradle 30.

Although described above with regard to a particular shape or size, this is for illustrative purposes only, as the cradle can include any number of different shapes and sizes suitable for positioning a laser marking device onto the pipe mount 20. Additionally, any number of other connection means and rotational means may be provided for connecting the components together and/or rotating, pivoting or otherwise manipulating the orientation of the components relative to each other.

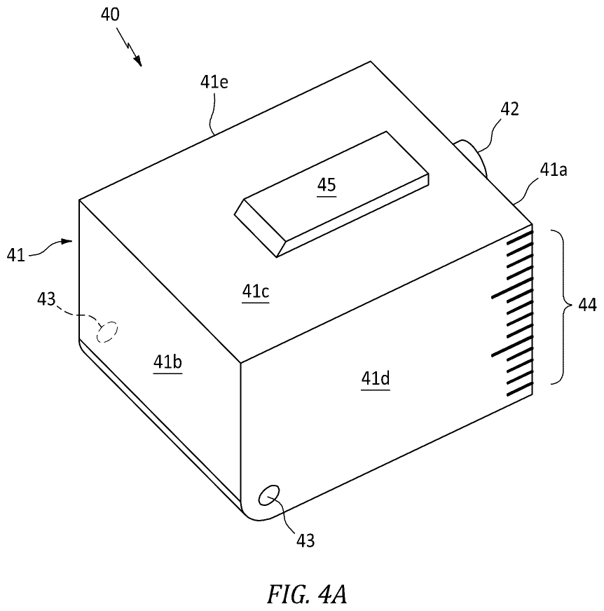

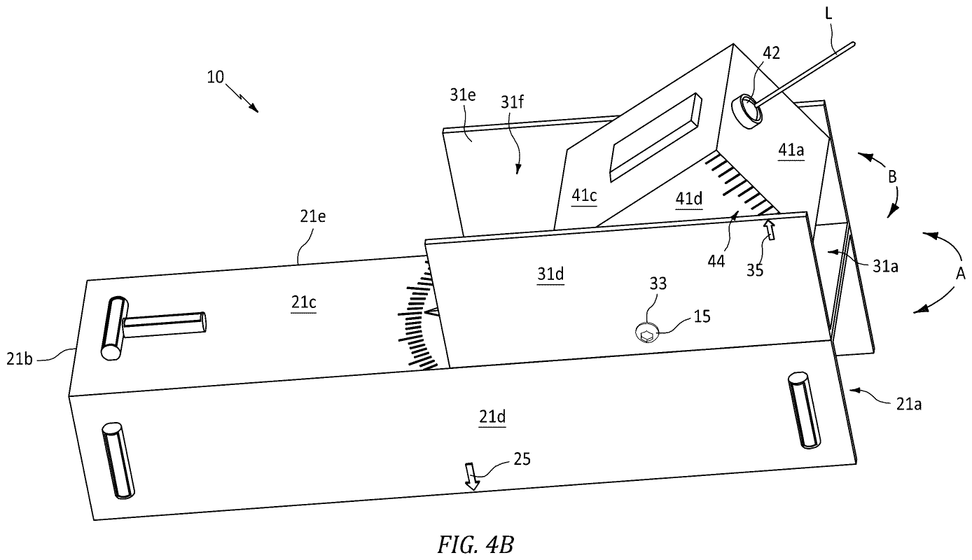

As shown at FIGS. 4A and 4B, the laser marking device 40 can include a main body 41 having a front end 41a, a back end 41b, a top wall 41c and a pair of sidewalls 41d and 41e that form a generally square or rectangular-shaped member that is positioned within the U-shaped channel 31f of the cradle 30.

The device 40 can include a battery-operated laser diode that is positioned within the body 41 that produces a focused, coherent beam of light L. A lens and IR filter 42 can be positioned along the front end 41a of the device through which the beam of light can pass. The device can function to dispense visible light along a horizontal axis and/or a vertical axis. One suitable laser marking device for use herein is described in U.S. Pat. No. 4,854,703, the contents of which are incorporated herein by reference.

In one embodiment, the device 40 can include threaded receptacles 43 along the side walls at locations complementary to the openings 33 on the cradle 30. To this end, bolts 13 or other such connectors can pass through the openings to secure the laser marking device 40 into the channel 31f. In the preferred embodiment, the receptacles will be positioned adjacent to the back end 41b of the device so as to permit the front end 41a to rotate in the second axis (e.g., vertically) relative to the cradle and pipe mount as shown at arrow B. Such a feature permits the beam L from the laser to be pointed up and down relative to the pipe mount 20 and cradle 30.

In one embodiment, the device 40 can include a plurality of vertical angle indication markings 44 that are positioned along one or both of the side walls 41d and 41e at a location adjacent to the front end 41a. The markings can function with the second angle indicator 35 on the cradle to provide a visual indication of the rotational angle at which the beam L from the laser device is oriented relative to the pipe mount and cradle. In the preferred embodiment, the markings can include a series lines, dots and/or numbers that are arranged to indicate any number of different relative angles such as 90, 60, 45, and 22½ degrees, for example, as these are the most commonly used type of elbow fittings. Of course, other angles and/or types of markings are also contemplated.

In one embodiment, the device 40 can also include a laser distance measuring module 45 which can function to detect and report the distance between the device 40 and another object, such as a target pipe described below. In one embodiment, the laser distance measuring module can be positioned along the top surface of the device 40 and can include a dedicated laser generator, circuitry and display screen.

One suitable distance measuring device for use herein is described in U.S. Patent Application No. 2008/0192227, the contents of which are incorporated herein by reference. Although described above with regard to separate components, other embodiments are contemplated wherein the measuring components are integrated into the design of the laser marking device so as to share electronic subcomponents.

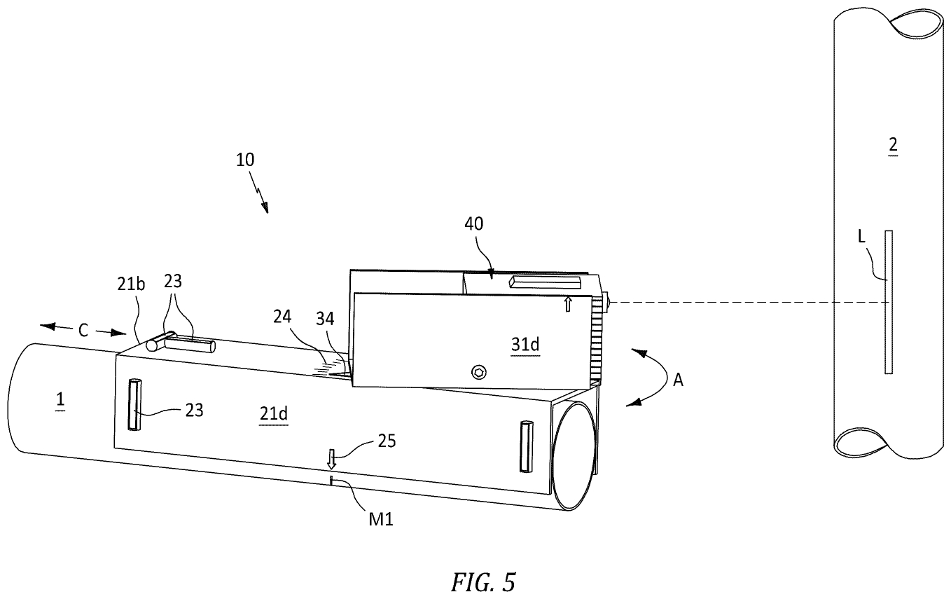

FIGS. 5-7 illustrate one embodiment of the system 10 in operation. As shown, the system 10 can be positioned onto a first pipe 1 that is to be connected to a second (target) pipe 2. When so positioned, the laser can be activated to generate the beam L, and the cradle can be rotated (arrow A) until the beam is engaging the center of the target pipe.

At this time, the angle between the pipes will be indicated by the first angle indicator and markings 24/34 to display the angle between the pipes and to inform the user of the elbow joint that is required. As shown by arrow C, the user may slide the system 10 along the length of the first pipe 1 to increase or decrease the first angle until a standard sized elbow joint (e.g., 90, 60, 45, and 22½ degrees) can be used. At this time, the user can place a first mark M1 on the pipe 1 at a location adjacent to the centerline mark 25.

Once marked, the user can cut the first pipe at the mark M1 location and attach the identified elbow joint 3. When secured onto the end of the first pipe 1, the joint 3 will be oriented directly toward the target pipe 2.

Next, the user can next position the system 10 so that it is level along the side of the first pipe 1 and can then activate the laser to generate the beam L. The marking device can then be rotated (see arrow B) until the beam is engaging the target pipe 2.

At this time, the angle between the pipes 1 and 2 will be indicated by the second angle indicator and markings 35/44, and the system can place a mark M2 on the second pipe 2. Mark M2 being used to indicate the location where the second pipe is to be cut in order to receive its connecting elbow 4. When so positioned, both elbows 3 and 4 will be aligned horizontally and vertically so as to each receive one end of an intervening pipe 5—the length of which can be determined by the measuring module 45—to complete the pipe assembly 6.

Although described above with regard to one particular method for using the system 10 in the first and second axes, this is for illustrative purposes only. To this end, the system can be oriented in an unlimited number of different positions along one or more pipes to allow a user to align and connect pipes at any number of different vertical, horizontal and/or diagonal orientations to each other utilizing custom or standard sized elbow fittings.

As to a further description of the manner and use of the present invention, the same should be apparent from the above description. Accordingly, no further discussion relating to the manner of usage and operation will be provided.

As described herein, one or more elements of the system 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
a pipe mount body having a front end, a back end, a top wall, and a first U-shaped channel;
a cradle body having a front end, a back end, a bottom wall, and a second U-shaped channel; and
a marking device that is positioned with the second U-shaped channel,
wherein the top wall of the pipe mount body and the bottom wall of the cradle body are connected together with the first U-shaped channel extending beneath the pipe mount body, and the second U-shaped channel extending above the pipe mount body.

2. The system of claim 1, wherein the first U-shaped channel includes a pair of sidewalls, and the U-shaped channel is configured to receive a pipe between the pair of sidewalls.

3. The system of claim 1, wherein the marking device is configured to emit a visual marker onto a secondary object.

4. The system of claim 3, wherein the cradle body is rotatably connected to the pipe mount body.

5. The system of claim 1, wherein the marking device includes a laser marker that is configured to selectively emit a visible laser beam toward a secondary object.

6. The system of claim 5, wherein the cradle body is configured to rotate along a first axis relative to the pipe mount body to point the visible laser beam outward along the first axis.

7. The system of claim 6, wherein at least one of the cradle body and the pipe mount body include a visual indication of an angle at which the laser beam is being pointed relative to the pipe mount body.

8. The system of claim 1, further comprising:
at least one level indicator device that is positioned along the pipe mount body.

9. The system of claim 1, further comprising:
a plurality of magnets that are positioned along the pipe mount body, each of the magnets being configured to secure the system onto a metallic pipe.

10. The system of claim 1, further comprising:
at least one strap that extends outward from the pipe mount body, each of the at least one strap being configured to secure the system onto a pipe.
